(19) United States
(12) Patent Application Publication
(10) Pub. No.: US 2013/0097904 A1
(43) Pub. Date: Apr. 25, 2013

(54) Illuminated Mattress Foot Protector For A Display Room

(71) Applicants: William D. Wright, JR., Chattanooga, TN (US); Chase McCord, Raleigh, NC (US); Peter H. Freeman, High Point, NC (US)

(72) Inventors: William D. Wright, JR., Chattanooga, TN (US); Chase McCord, Raleigh, NC (US); Peter H. Freeman, High Point, NC (US)

(73) Assignee: Wright of Thomasville, Inc.

(21) Appl. No.: 13/279,444

(22) Filed: Oct. 24, 2011

(51) Int. Cl. G09F 13/02; A47G 9/00

(52) U.S. Cl. 40/559

(57) ABSTRACT

A linear array of LEDs or other light emitting device(s) extends across at least a side fabric panel of a display mattress foot protector at a point immediately above visual indicia thereon in such manner as to illuminate the visual indicia.

### FIELD OF THE INVENTION

The present invention relates to a mattress foot protector and to the concept of illuminating a side panel thereof.

### BACKGROUND OF THE INVENTION

Mattresses are sold in retail showrooms. Typically, display mattresses are arranged on the floor so that the prospective purchaser can peruse the various types of mattresses offered by that retailer. In addition to evaluating various promotional materials in the showroom, the prospective buyer might “test” the mattress. This “test” involves lying on the mattress to evaluate softness, firmness or other attributes desirable to the purchaser. Lying on the mattress can result in damage, soiling, wear and tear. Retail showrooms are high traffic areas, and mattresses may be repeatedly tested and damaged.

Foot protectors for mattresses have been used to minimize damage to display mattresses in retail showrooms. Examples are described in U.S. Pat. Nos. 6,845,532; 6,216,292; and 6,014,782. It is also known to provide indicia, such as product information, on foot protectors so that they also serve to advertise and market the mattress on which the foot protector is placed.

Retail showrooms for mattress sales are usually quite crowded with a large number of mattresses of different brands and having different characteristics. The lighting in certain areas of these showrooms is often inadequate for a potential consumer to see and read product information which is displayed on the mattress.

### SUMMARY OF THE INVENTION

In the display and sale of mattresses in showrooms, a potentially good area for advertising or product information is on the generally vertically extending side panels of the increasingly popular foot protectors. However, because the panel hangs vertically, this area is generally not well illuminated and hard to see. This invention addresses this situation by providing a linear light source at or across the top of that side panel.

According to one aspect, the foot protector includes a generally elongated fabric panel of such width as to cover the lower end of a mattress on display, and hang down from an upper perimeter of the mattress on either side a distance long enough to cover at least a substantial portion of a mattress side. The portion of the fabric panel which extends over at least one side has visual indicia either formed thereon, or affixed thereto, and includes at least ornamentation, advertising media, product information (pricing, product specifications and the like), or combinations thereof. In this aspect, the linear light source is a linear array of light emitting diodes (hereinafter LEDs) which extends across at least some of the width of the fabric panel at a point immediately above the visual indicia in such manner as to provide a light source illuminating the visual indicia. In this embodiment, the linear array of LEDs may be in the form of a flexible LED strip with the LEDs arranged in series, and wherein the strip also comprises a printed circuit board (PCB). Other linear arrangements of LED's are possible, or even linear arrangements of other types of lamp(s).

According to another aspect, in some situations only a fabric panel may extend over one side of the mattress, which may also include at least ornamentation, advertising media, product information, and combinations thereof. Again, a linear light source such as a linear array of LED light sources extends across at least some of the width of the fabric panel. The fabric panel and linear array of LEDs attaches to the mattress proximate the upper perimeter of the mattress with a hook and loop or other suitable fastener. Again, the linear array of LEDs is located on the fabric panel at a point immediately above the visual indicia in such a manner as to illuminate the visual indicia.

In yet another aspect, just the linear array of LEDs or other linear light source with one type of means for attachment to the foot protector at the appropriate location might be separately provided.

The term “foot portion,” as used herein, means the lower inches (10-30 inches) of the upper surface of the mattress where a customer's feet would rest if the customer were to fully lie on the mattress to test the comfort and support. The term “foot protector,” as used herein, means a device used to cover at least part of the foot portion of a mattress. The term “marketing information” refers to any of the following including: advertising materials, sales materials, manufacturer's logos and trademarks, promotional materials or the like, in the form of pictures, and/or any other form of media. The term “LED,” as used herein, refers to a light-emitting diode, which is a semiconductor light source well known in the electronic arts. The term “linear array of LEDs,” refers to multiple LEDs which are interconnected in series. “Linear light source” on the other hand is intended to be any lighting arrangement that provides effective lighting across and down the side panel to illuminate the indicia thereon sufficiently for customers to more adequately see it. The term “PCB,” as used herein, means a printed circuit board, which is commonly known as a support for a variety of electronic components and circuitry, having one surface printed with electrically conductive pathways between the components. As used herein, PCB is also understood to include flexible strips capable of performing the same function.

### BRIEF DESCRIPTION OF THE DRAWINGS

FIG. 1 is a front perspective view of a mattress with one embodiment of the illuminated foot protector of the present invention.

FIG. 2 is a close-up perspective view of the illuminated foot protector of FIG. 1.

FIG. 3 is an alternative embodiment for illuminating product information on a mattress on display.

FIG. 4 is a sectional view of the foot protector of FIG. 2, illustrating the sleeve for holding the linear array of LEDs.

FIG. 5 is a sectional view of the foot protector of FIG. 4, illustrating the placement of the linear array of LEDs within the sleeve.

FIG. 6 is a perspective view of one embodiment of the linear array of LEDs mounted on a tubular holder.

FIG. 7 is a perspective view of an alternative embodiment of the linear array of LED lights sources mounted within a transparent tube.

FIG. 8 is a circuit diagram of the linear array of LEDs for one embodiment of the present invention.

### DETAILED DESCRIPTION

Certain exemplary embodiments of the present invention are described below and illustrated in the accompanying figures. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art and all such alternate embodiments, modifications, and improvements are within the scope of the present invention.

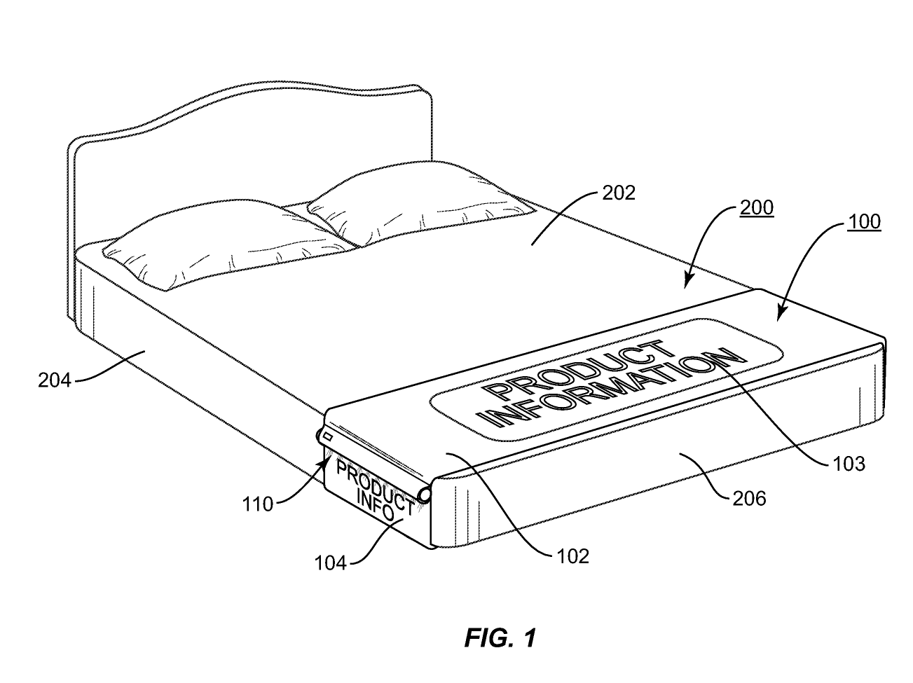

Referring first to FIG. 1, a removable foot protector 100 is shown positioned on a conventional mattress 200, such that the foot portion of the mattress is protected against soiling, when a consumer “tests” the mattress 200 in the retail showroom. Because it is removable, the foot protector 100 remains in the showroom when the mattress 200 is removed. As is conventional, the mattress 200 comprises an upper sleeping surface 202, opposed sides 204, and opposed ends 206. As shown, marketing information 103, 105 directed to a potential customer may be affixed at several locations on the foot protector. The foot protector 100 may be formed of any textile material, including, but not limited to, woven, knit, non-woven materials, or a combination of materials, including non-textile materials, such as plastics, suitable for use as a foot protector. In the exemplary embodiment shown, the foot protector 100 is formed from a fabric having sufficient thickness so that it will not deform too easily when a consumer places his or her feet on it while lying down. The foot protector 100 may further include a decorative hem or other stitching along its perimeter, to minimize fraying and to also provide a desirable aesthetic effect. The foot protector 100 also may include an embroidered image, design, logo or other design effect.

The foot protector 100 is shown having a length at least as wide as the mattress 200 so that ends, or side portions, 104 of the foot protector 100 will hang over the sides 204 of the mattress to a length sufficient to provide a suitably sized surface for affixing indicia thereon. Sometimes the side portions 104 are tucked beneath the mattress 200 and sometimes they just hang down loosely. Mechanical fasteners (not shown) may be used in conjunction with the foot protector 100 to secure the foot protector 100 to the mattress 200, without distracting from the aesthetic effect of the display mattress 200 and foot protector 100 combination.

It is to be understood that the foot protector 100 of the present invention may be used on any type of mattress. For example, twin, twin XL, full, queen, king, and the “California king” are exemplary sized mattresses. Further, the shape and size of the foot protector 100 may be varied without departing from the scope of the invention.

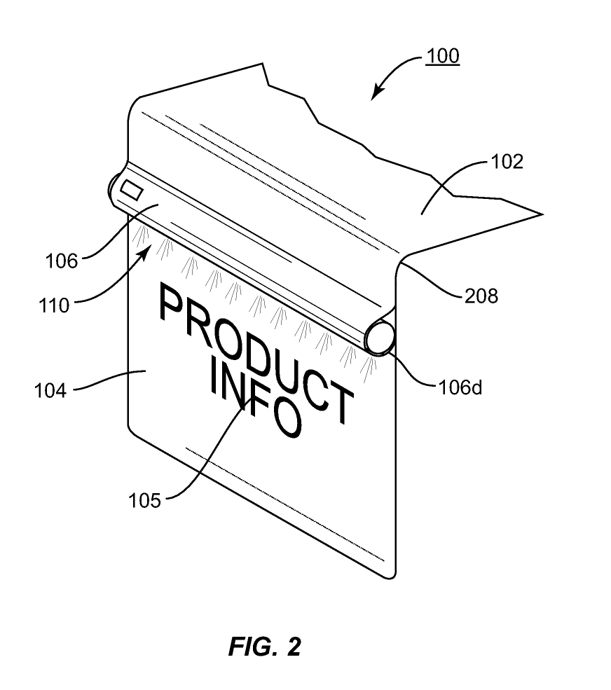

As best shown in FIG. 2, the side portions 104 of the foot protector 100 have indicia 105 formed thereon or affixed thereto. The indicia 105 may include ornamentation, advertising media, product information (such as pricing, specifications, etc.), or combinations thereof. The indicia 105 may be sewn into the fabric, bonded to the fabric with suitable adhesives, or inserted into a transparent cover (not shown) that is affixed over one or both side portions 104.

In order to illuminate the indicia 105 on side portion 104, a linear light source 110 extends across the width of side portion 104 at a location above the indicia 105. While the preferred embodiment utilizes a linear array of LED's, other light emitting devices may be used, such as EL material, EL wire, neon tubes, fluorescent tubes, etc.

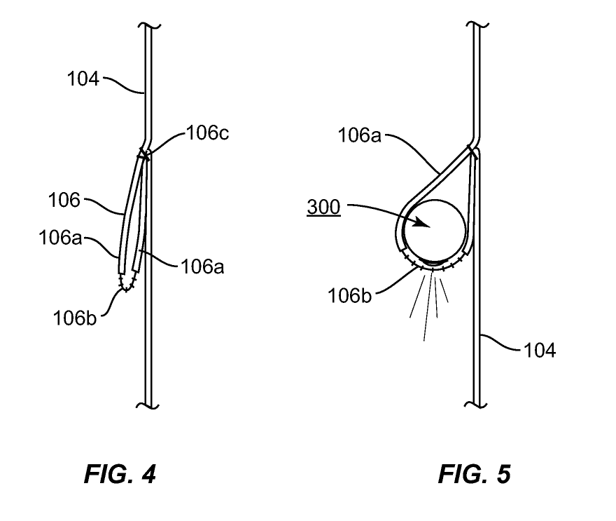

In FIGS. 2, 4, and 5, a sleeve 106, or other type of holder, is affixed to the foot protector 100 proximate the upper perimeter 208 of the mattress 200. Obviously the linear array of LEDs may be attached to the foot protector in other ways. As best shown in FIG. 4, in one exemplary embodiment, the front and back portions 106a of the sleeve may comprise material of the same type and color as the material forming the top 102 and side portions 104 of the foot protector 100; however, it may comprise a different material and different color as the marketing and business situation warrants. The sleeve 106 is affixed, by stitching 106c or other suitable means, to the foot protector 100 proximate the upper perimeter 208 of the mattress 200. While the sleeve 106 is illustrated as extending the entire width of side panel of portion 104, it may be shorter, so long as sufficient light is provided. Located in the loop forming of the sleeve 106 and extending the horizontal length of the sleeve 106, is a window 106b formed in the sleeve 106, which may be in the form of an open fabric structure, such as a mesh, or a transparent plastic, which permits light transmission therethrough. When the sleeve 106 is affixed to the foot protector 100, the window 106b will be situated proximate the bottom of the sleeve 106 so that the linear array 300 of LEDs will be oriented downwardly onto the surface of the side portions 104 when the linear array 300 is inserted into the sleeve 106, and so that none of the LEDs are directed outwardly or upwardly where the light could be damaging to a consumer's eyes. This is best shown in FIG. 5, which illustrates a linear array 300 of LEDs inserted into the sleeve 106. At least one end 106d of the sleeve 106 is open to permit easy installation and removal of the linear array 300 of LEDs.

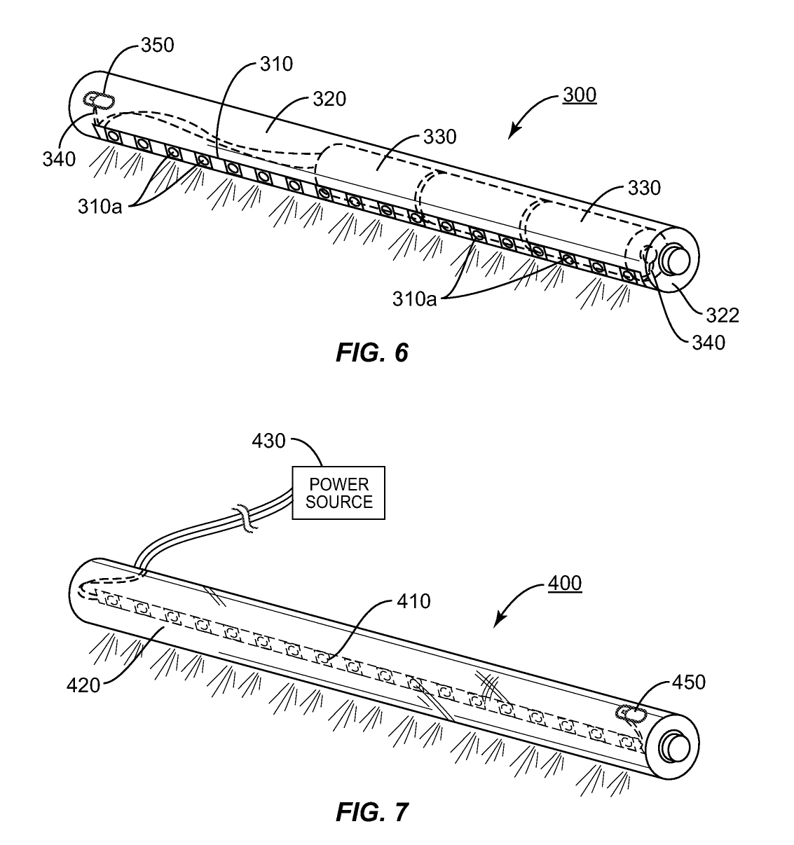

Turning now to FIG. 6, a first embodiment of the linear array 300 of LEDs is illustrated. In this embodiment, the linear array 300 comprises a plurality of LED lights 310a mounted on, and integral with a flexible printed circuit light strip 310. In this embodiment, the flexible printed circuit light strip 310 includes between about 9 and 27 LED lights 310a, depending upon the width of the foot protector 100 and the degree of illumination required, and is available from OPTEK Technology Inc. of Carrollton, Tex. as Item No. OVQ12S30×7. This is an LED light strip that is both flexible and scalable using high brightness LEDs, and may be operated with a single 12V power supply. While a 12V DC system is illustrated, because they are already commercially available as an “off the shelf” item, other voltages are also possible, particularly lower voltage systems. Also, AC current could be used in an appropriately modified circuit as a power source to operate the LED's. This flexible and scalable LED light strip 310 is provided in a length with 30 LED lights 310a, but may be cut at designated points along the strip to shorten the circuit and/or create multiple independent circuits with a selected number of LED lights 310a in each circuit. FIG. 8 is illustrative of the electrical circuit of this LED light strip, with 30 LED lights 310a and the appropriately sized resistors a′ in series with the LEDs.

Dual-sided tape (not shown) provides an easy alternative installation onto multiple types of surfaces. Strips of 30 LEDs 310a are available which utilize an InGaN material, have a dominant wavelength of about 5500° K, and produce an average illumination of about 68 lux at 0.5 meters. In the embodiment shown in FIG. 6, the flexible printed circuit light strip 310 is affixed on the outer surface of an elongated tubular enclosure 320. To ensure that the printed circuit light strip 310 remains affixed to the elongated tubular enclosure 320 for long-term use, a heat-shrink material (not shown) may be used to substantially encapsulate the entire flexible printed circuit light strip 310 and tubular enclosure 320, except for end caps 322 which enclose the ends of the elongate tubular enclosure 320. EP301, 1½ clear 48″ BK, available from 3M Electronic Specialty is an example.

The elongate tubular enclosure 320 in this embodiment is an opaque polyvinylchloride (PVC) tube that is dimensioned with a length substantially equal to the width of the sleeve 106, and an inner diameter sufficient to hold DC batteries 330 capable of providing the required 12V power supply. For example, the elongated tubular enclosure 320 may be sized to hold eight 1.5 v batteries, or four 3.0 v batteries, among others. Electrical connections 340 provide electrical connectivity between the batteries 330 and the flexible printed light strip 310, as is well known in the art. So that the linear array of LEDs 300 is a self-contained unit, and to facilitate ease of operation of the assembly 300, a conventional on-off switch 340 may be mounted on the exterior of the elongated tubular enclosure 310.

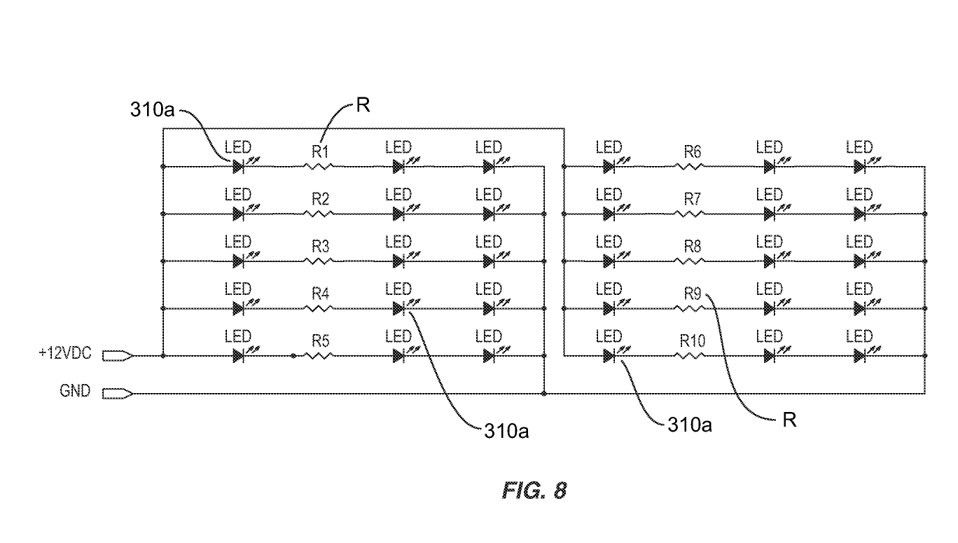

Turning now to FIG. 7, an alternative embodiment 400 of the linear array of LEDs is illustrated. In this embodiment, the flexible printed circuit light strip 410 is affixed inside a substantially transparent elongated tubular enclosure 420. The flexible printed circuit light strip 410 may be mounted to a rigid substrate before being placed in the transparent tubular enclosure 420, or may alternatively be affixed to the inside of the transparent tubular enclosure 420. In this embodiment, the power source 430, comprising a plurality of batteries (not shown), may be a separate unit from the transparent tubular enclosure 420, and may be positioned out of the consumer's view. Again, the assembly 400 may comprise an on-off switch 450 on the tubular enclosure 420, proximate the power source 430, or installed inline between the tubular enclosure 420 and power source 430.

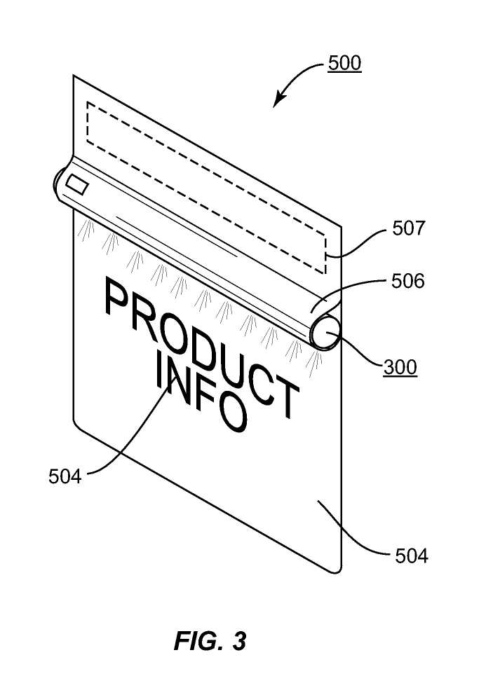

In circumstances where a foot protector 100 is not used, where the display is to be used with a side panel that is not part of a foot protector, or in the case where additional illuminated indicia is desired, an alternative embodiment of the present invention is provided. Referring now to FIG. 3, this alternative embodiment is shown as illuminated indicia display 500, and comprises a fabric panel 504, similar in all respects to the side portions 104 of the foot protector 100 described above, with visible indicia 505 thereon. Since this embodiment lacks an upper surface 102, the display 500 may be affixed to the display mattress 200 such that the fabric panel 504 attaches to the side 202 of the mattress 200 and hangs over at least one side 204 of a display mattress 200. This may be accomplished by employing a hook and fastener 507 on the back of the fabric panel 504 and the side 202 of the mattress 200 proximate the upper perimeter 208 of the mattress 200. The fabric panel 504 also is dimensioned to carry visual indicia 505 selected from the group consisting of at least ornamentation, advertising media, product information, and combinations thereof. A sleeve 506 is constructed in the same manner as the sleeve 106 for the foot protector. Likewise, the linear array of LED light sources 300 also extends across at least some of the width of the fabric panel 504 at a point immediately above the visual indicia in such manner as to illuminate the visual indicia, and is formed in the same manner as the linear array of LED light sources 300 described above.

Turning again to FIG. 7, the power source 430 of this embodiment of the present invention may alternately comprise an AC power source with appropriate electrical circuitry or other DC or AC power sources.

Lastly, the present invention may further comprise a motion sensing device, i.e., a motion detector, so that at least one of the 12 v LED printed circuit strip and/or an audio device will be automatically powered/activated. The Panasonic MN34111 is an example of an appropriate motion sensor design. So arranged the motion sensor would be activated as persons approach the mattress/display.

The above descriptions of preferred embodiments of the invention are intended to illustrate various aspects and features of the invention without limitation. Persons of ordinary skill in the art will recognize that certain changes and modifications can be made to the described embodiments without departing from the scope of the invention. All such changes and modifications are intended to be within the scope of the appended claims. Features from one embodiment or aspect may be combined with features from any other embodiment or aspect in any appropriate combination. For example, any individual or collective features of method aspects or embodiments may be applied to apparatus, product or component aspects or embodiments and vice versa.

We claim:

1. A foot protector for display mattresses, comprising:
(a) a generally elongate fabric panel of such width as to cover the lower end of a mattress on display and hang down from an upper perimeter of the mattress a distance long enough to cover at least a substantial portion of a mattress side;
(b) the portion of the fabric panel which extends over at least one side carrying visual indicia selected from the group consisting of at least ornamentation, advertising media, product information, and combinations thereof; and
(c) a linear light source extending across at least a portion of the width of the fabric panel at a point above the visual indicia in such manner as to illuminate the visual indicia.

2. The foot protector of claim 1, wherein the linear light source comprises an array of LEDs.

3. The foot protector of claim 3, further comprising a holder affixed to the elongate fabric panel proximate the upper perimeter of the mattress for holding the linear array of LED light sources.

4. The foot protector of claim 3, wherein the holder comprises a sleeve affixed to the elongate fabric panel, the sleeve having at least one open end and sized to receive the linear array of LED light sources.

5. The foot protector of claim 4, wherein the sleeve includes a mesh or transparent plastic window for illumination of the linear array of LED light sources therethrough onto at least one portion of the fabric panel which extends over the at least one side.

6. The foot protector of claim 2, wherein the linear array of LED lights comprises a plurality of LED lights mounted on a flexible printed circuit.

7. The foot protector of claim 6, wherein the linear array of LED lights includes a 12 volt power supply.

8. The foot protector of claim 6, wherein the linear array of LED lights is mounted on an outer surface of an elongated tubular enclosure, dimensioned to hold a plurality of DC batteries.

9. The foot protector of claim 8, further comprising an on-off switch mounted on an outer surface of the tubular enclosure.

10. The foot protector of claim 6, wherein the linear array of LED lights is mounted within an elongated transparent tube, wherein the linear array of LED lights is electrically interconnected to a DC power source.

11. The foot protector of claim 2, further comprising a motion detector electrically interconnected to the linear array of LED lights for activating the linear array of LED lights when a consumer approaches the mattress on display.

12. The foot protector of claim 2, further comprising a solar-powered cell electrically interconnected to the linear array of LED lights for powering the linear array of LED lights.

13. Illuminated visual indicia display for mattresses, comprising:
(a) a fabric panel which extends over at least one side of a display mattress and carries visual indicia selected from the group consisting of at least ornamentation, advertising media, product information, and combinations thereof; and
(b) a linear light source extending across at least a portion of the width of the fabric panel at a point above the visual indicia in such manner as to illuminate the visual indicia.

14. The illuminated visual display of claim 13 wherein the linear light source comprises an array of LEDs.

15. An illuminated visual display for mattresses of type in which a fabric panel extends over at least a portion of a wall of a display mattress and carries visual indicia selected from the group consisting of at least ornamentation, advertising media, product information, and combinations thereof, the illuminated visual display comprising a linear array of LEDs, and a means for attaching the linear array to the fabric panel in such a way that the array extends across at least a portion of the width of the fabric panel above the visual indicia in such a manner as to illuminate the visual indicia.

16. The illuminated visual indicia display of claim 15, further comprising a holder affixed to the fabric panel proximate the upper perimeter of the mattress for holding the linear array of LEDs.

18. The illuminated visual indicia display of claim 16, wherein the linear array of LEDs comprises a plurality of LEDs mounted on a flexible printed circuit.

19. The foot protector of claim 15, further comprising a motion detector electrically interconnected to the linear array of LED lights for activating the linear array of LED lights when a consumer approaches the mattress on display.
